(19) United States
(12) Patent Application Publication
(10) Pub. No.: US 2017/0270231 A1
(43) Pub. Date: Sep. 21, 2017

(54) MASKLESS PATTERNING

(71) Applicant: VueReal Inc., Waterloo (CA)

(72) Inventor: Gholamreza Chaji, Waterloo (CA)

(21) Appl. No.: 15/461,968

(22) Filed: Mar. 17, 2017

(30) Foreign Application Priority Data
Mar. 18, 2016 (CA) 2924160

(51) Int. Cl. G06F 17/50

(52) U.S. Cl. CPC G06F 17/5072; G06F 17/5081

(57) ABSTRACT

A method of transferring a pattern to a photosensitive material comprises aligning a display with a substrate by using an image sensor or camera, and showing the pattern in the display. The display may have a physical alignment mark, or alignment marks with a color having a wavelength that does not cause the photosensitive material to react. The pattern to be transferred is adjusted to stay aligned with substrate features and then shown on the display. The display sweeps at least part of the substrate while the content of the display is scrolling to cover the pattern to be transferred. The speed of sweeping and scrolling is controlled by the required exposure time.

### CROSS-REFERENCE TO RELATED APPLICATIONS

This application claims priority to Canadian Patent Application No. 2,924,160, filed Mar. 18, 2016, which is hereby incorporated by reference herein in its entirety.

### FIELD OF THE INVENTION

The present invention relates to the fabrication and patterning of different layers for forming interconnects, devices or other structures on a substrate.

### BRIEF SUMMARY

In accordance with one embodiment, a method of transferring a pattern to a photosensitive material comprises aligning a display with a substrate by using an image sensor or camera, and showing the pattern in the display. The display may have a physical alignment mark, or alignment marks with a color having a wavelength that does not cause the photosensitive material to react. The pattern to be transferred is adjusted to stay aligned with substrate features and then shown on the display. The display sweeps at least part of the substrate while the content of the display is scrolling to cover the pattern to be transferred. The speed of sweeping and scrolling is controlled by the required exposure time.

One embodiment is a method of transferring pattern to a photosensitive material which comprises aligning a display to the substrate by using image sensor or camera and showing the intended pattern in the display. One embodiment of the display has fixed patterns for transferring to the photosensitive material. In another embodiment, the display can show programmable patterns. Here, the alignment procedure may use some physical alignment marks in the display.

In another embodiment, the display shows alignment marks with light that is not reacting to the photosensitive materials for alignment procedure.

In a further embodiment, an intended pattern is modified to be aligned with the substrate features and then show in the display

In yet another embodiment, the display can be the same size as the substrate.

In a still further embodiment, the display sweeps the substrate or part of the substrate while the content of the display is scrolling to cover the intended pattern for transfer. Here, the speed of scrolling and sweeping is controlled by the required exposure time.

In one structure, the sensor pixels are distributed between the display sensors.

In another structure, two separate display and image sensors are used.

### BRIEF DESCRIPTION OF THE DRAWINGS

The foregoing and other advantages of the disclosure will become apparent upon reading the following detailed description and upon reference to the drawings.

FIG. 1 illustrates a patterning system having a display and an imager.

FIG. 2 is a flow chart of a method for transferring a pattern to another medium (e.g., photoresist).

FIG. 3 is a flow chart for transferring a pattern to another medium (e.g., photoresist).

FIG. 4 is a schematic illustration of a pattern transfer system with a separate display and imager (camera).

FIG. 5 is a schematic illustration of a pattern transfer system with a combined display and imager (camera).

FIG. 6 is a schematic illustration of a system in which an image sensor and a display are connected together and move together across a substarte.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

This document discloses various methods for using a display to transfer a pattern to a light sensitive medium. Here, the pattern is shown in a display creating light in the operating range of the light sensitive medium. The pattern is then developed by other processing steps, such as backing, developing, etching, etc.

The display may include some optics or in some embodiments separate optic structures are listed. The terms “sensor array” and “camera” are used interchangeably. Here, the display can have one or more fixed patterns that can be shown. To show a different pattern, a new display may be used. In another case, the display can show a programmable pattern. Here, the display has an interface that permits the pattern to be programmed into the display. The display can switch at once to a new pattern or it can change row by row. The sensor can be a two-dimensional array or one-dimensional. Multiple sensors (camera) may be used in several different locations to offer better and faster alignment. The display can be a two-dimensional or one-dimensional structure. It can be a monocolor or multi-color display. Multiple displays may be used to speed up the pattern transfer function.

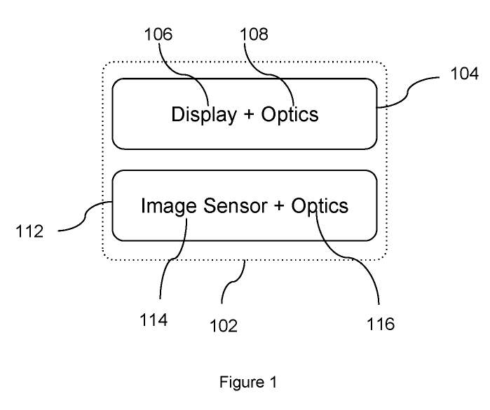

FIG. 1 is a block diagram of a pattern transfer system 102 using a display system 104 as a medium to create the pattern. Here, a display 106 and optics 108 can be two separate parts or fully integrated. Also, an image sensor system 112 is used to control the alignment of the patterns with previous structures or patterns. The sensor system 112 consists of an actual image sensor array 114 and optics 116. The optics 116 can be part of the sensor array 114 or a separate structure. Also, one can share the display optics 108 and the sensor optics 116.

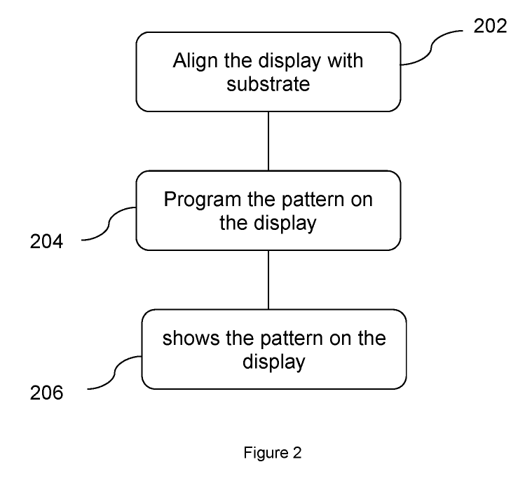

FIG. 2 illustrates operational steps for transferring a pattern to a layer of photosensitive material deposited on the substrate using a display. During the first step 202, the display is aligned with the substrate, previous structures or previous patterns. In one case, the physical dimension of display is used as cue/mark for alignments. In another case, a pattern is shown in the display and used as alignment mark. To avoid damaging the photosensitive material on the substrate, a different color (wavelength) can be used for creating the alignment marks on the display (e.g., red, yellow or other colors). The alignment pattern/marks can be the same as the actual pattern intended to be transferred to the photosensitive layer. In another case, physical alignment marks are added into the display structure. During the second step 204, the intended pattern is created by the display. To properly transfer the pattern to the photosensitive material, it needs to be exposed to the pattern for a minimum given time (exposure time). Thus, the image needs to stay on the display for a given time during third step 206. These steps can be repeated to cover the entire substrate. The display can move to new location either as step function or a sweeping function. In the case of a step function, the display is transferred to a new location while it is not showing a pattern that can damage the photosensitive layer. After the display is in the intended location, it shows an adequate pattern for transfer. In one case, the locations may have some overlap. In the case of sweeping, as the display is moving with a predefined speed, the pattern is scrolling to match the new area. In this case, the scrolling and sweeping speed can control the pattern exposure time or a combination of scrolling/sweeping speed and a wait step 206 can control the pattern exposure time. One can repeat the alignment step 202 periodically to increase the speed.

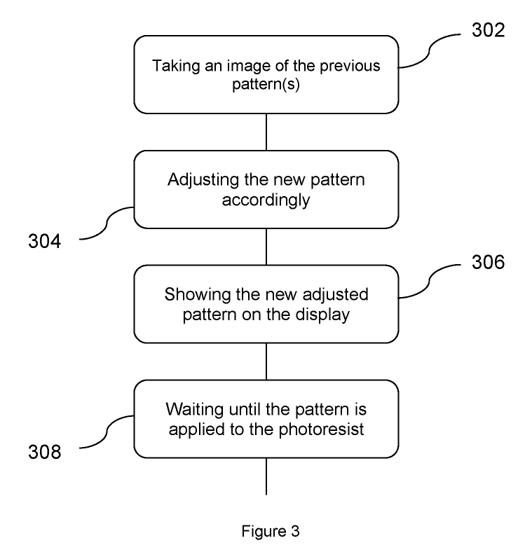

In another embodiment, instead of physical alignment, the pattern on the display is modified to provide alignment with previous patterns. This structure, offers faster alignment with less complicated, high accuracy physical moving parts. FIG. 3 illustrates the main steps for creating alignment using display picture. Here, the image sensor provides an image of a previous pattern 302 (this can be the entire pattern, a part of it or just an alignment mark). In addition, the image may also include an image of the alignment in the display (either its physical dimension, alignment mark, pattern, etc.) in accordance with previous image. During the next step 304, the pattern image is modified to become aligned with the previous pattern or structure on the substrate. These steps 302, 304 can be repeated to achieve better alignment.

During a third step 306, the modified pattern is created by the display. To properly transfer the pattern to the photosensitive material, it needs to be exposed to the pattern for a minimum given time (exposure time). Thus, the image needs to stay on the display for a given time during a fourth step 308. These steps can be repeated to cover the entire substrate. The display can move to a new location either as step function or sweeping function. In the case of a step function, the display is transferred to a new location while it is not showing a pattern that can damage the photosensitive layer. After the display is in the intended location, it shows the adequate pattern for transfer. In one case, the locations may have some overlap. In the case of sweeping, as the display is moving with a predefined speed, the pattern is scrolling to match the new area. In this case, the scrolling and sweeping speed can control the pattern exposure time, or a combination of scrolling/sweeping speed and a wait step 308 can control the pattern exposure time. One can repeat the alignment step 202 periodically to increase the speed. Here, one can first align the display with a previous pattern as described before, and use the display content adjustment for fine tuning the alignment.

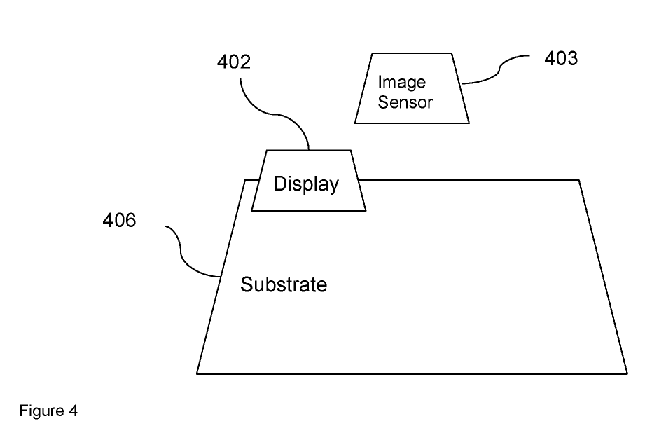

FIG. 4 illustrates a system with a separate display 402 and image sensor 403. Here the display can cover the entire substrate 406 or just part of it. Also, multiple image sensors 404 can be used. The display 402 shows the patterns either for alignment or pattern transfer. All the above procedures can be applied to this structure or all the other structures identifed here.

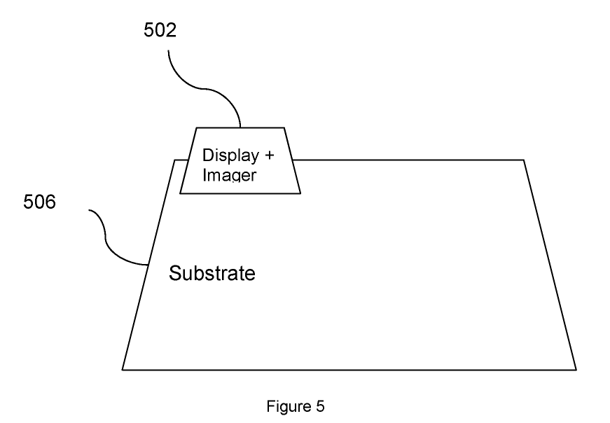

FIG. 5 illustrates a system with an image sensor integrated into the display 502. Here part of the display 502 can be the image sensor. In another structure, the pixels for image sensors can be distributed between the display pixels and thus cover the same area on the substrate 506.

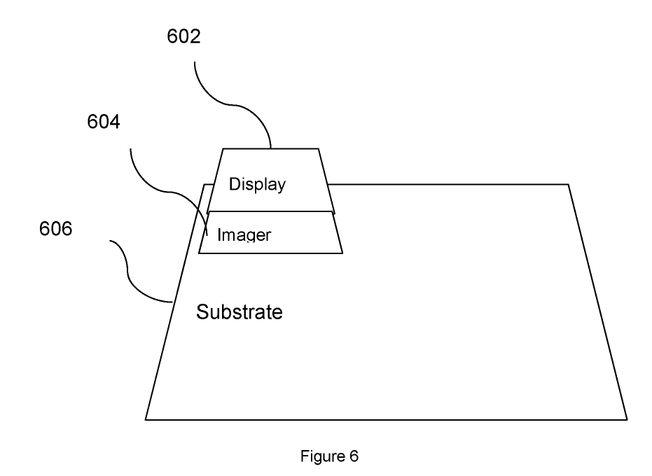

FIG. 6 illustrates a system where an image sensor 604 and a display 602 are connected together and move together across a substrate 606.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A method of transferring a pattern to a photosensitive material, said method comprising
aligning a display with a substrate by using an image sensor or camera, and
showing the pattern in the display.

2. The method of claim 1 in which the display has a physical alignment mark.

3. The method of claim 1 in which the display shows alignment marks with a color having a wavelength that does not cause the photosensitive material to react.

4. The method of claim 1 in which the pattern to be transferred is adjusted to stay aligned with substrate features and then shown on the display.

5. The method of claim 1 in which the display sweeps at least part of the substrate while the content of the display is scrolling to cover the pattern to be transferred.

6. The method of claim 5 in which the speed of sweeping and scrolling is controlled by the required exposure time.
